(19) United States
(12) Patent Application Publication
(10) Pub. No.: US 2007/0210776 A1
(43) Pub. Date: Sep. 13, 2007

(54) Switching power source apparatus

(75) Inventor: Tomohiro Oka, Chiba-shi (JP)

Correspondence Address: BRINKS HOFER GILSON & LIONE, P.O. BOX 10395, CHICAGO, IL, 60610, US

(73) Assignee: Seiko Instruments Inc., Chiba-shi (JP)

(21) Appl. No.: 11/704,679

(22) Filed: Feb. 8, 2007

(30) Foreign Application Priority Data
Feb. 9, 2006 (JP) JP2006-032563

(51) Int. Cl. G05F 1/00

(52) U.S. Cl. 323/283

(57) ABSTRACT

There is provided a switching power supply device which is capable of reducing an influence of noises and also reducing a consumption current of a control circuit. A pseudo-random number generator circuit (12) generates random number data for determining frequencies of switching signals of MOS transistors (M1) and (M2). A chopping wave oscillation frequency (a frequency of a switching signal) of a chopping wave oscillator (3) randomly changes according to the random number data that is generated by the pseudo-random number generator circuit (12). A current control circuit (1) and a current control circuit (2) control consumption currents that flow in the chopping wave oscillator (3) and an error amplifier (8) according to a change (a change in the frequency of the switching signal) in the random number data that is generated by the pseudo-random number generator circuit (12).

### TECHNICAL FIELD

The present invention relates to a switching power supply device for outputting a DC voltage with a given voltage value, and more particularly, to a switching power supply device that is capable of controlling a frequency of a switching signal of a switching element at random, and controlling a consumption current that flows in a given circuit section (such as an error amplifier) according to the frequency of the switching signal which is controlled at random.

### BACKGROUND ART

Up to now, a switching power supply device (for example, DC/DC converter) of a pulse width modulation (PWM) control system is employed as an internal power supply of diverse electronic devices since the switching power supply device is capable of supplying a DC power supply with a stable voltage value.

However, noises of a high frequency enter an electronic circuit from the switching power supply device, and such noises frequently induce the malfunction of the electronic device. For that reason, up to now, the switching frequency is controlled at random, to thereby reduce an influence of the noises from the switching power supply device.

FIG. 6 is a diagram showing a structural example of a conventional switching power supply device. The switching power supply device includes a chopping wave oscillator 3, a PWM comparator 4, a switch drive control circuit 5, a synchronous rectifier circuit 6 that is made up of a switching PMOS transistor M1 and a switching NMOS transistor M2, an external inductor L, an external capacitor C, a reference voltage generator circuit 7, an error amplifier 8, a stabilizer circuit 9, and an output voltage detector circuit 10 including resistors R1 and R2.

Reference numeral 11 denotes an input power supply (DC power supply), and a supply voltage of the input power supply 11 is switched according to a PWM pulse signal of a constant frequency, to thereby control an output voltage value to a constant value. A ratio of the output voltage value from the switching power supply device and the voltage value of the input power supply 11 is equal to a duty ratio of the switching signal that is generated by the PWM comparator 4.

The switch drive control circuit 5 switches over the MOS transistors M1 and M2 of the synchronous rectifier circuit 6, thereby shaping the value of a current that flows in the external inductor L into a chopping wave. Then, the current change is smoothed by the external capacitor C into a DC output. However, the current change cannot be completely removed by the external capacitor C, and a voltage variation of about several tens of mV is put on a power supply line as a power supply ripple.

In particular, in a small electronic device, because it is necessary to reduce the value of the external capacitor C, the switching power supply device of the power supply circuit is switched at a frequency of 1 MHz or higher. When the noises that are generated at such a high frequency enter the electronic device, not only the malfunction of the electronic device is induced, but also the noises are leaked to the external of the device, to thereby adversely affect the external of the device.

A conventional random switching power supply is disclosed (refer to, JP 07-245942 A). According to the technique of the conventional random switching power supply, in order to solve the problems of the above type, the switching frequency is changed at random, thereby enabling a peak value of the noise spectrum which is generated by the power supply ripple to be reduced. In the above-described power supply circuit shown in FIG. 6, it is possible that the oscillation frequency of the chopping wave oscillator 3 may be changed by using, for example, a pseudo-random number generator circuit 12 to change the switching frequencies of the MOS transistors M1 and M2 at random.

### SUMMARY OF THE INVENTION

However, in a conventional power supply device for conducting random switching, it is necessary to allow a large current in an error amplifier in correspondence with the maximum frequency of the PWM output. This is because a large amount of consumption current needs to flow in order to increase a response speed of an error amplifier (for example, a differential amplifier). Accordingly, in the case where the switching frequency is low, an excessive current is allowed to flow in the error amplifier, resulting in such a problem that an electric power is consumed uneconomically.

The present invention has been made in order to solve the above problems, and therefore an object of the present invention is to provide a switching power supply device which is capable of reducing a consumption current of a control circuit while a noise reduction effect is maintained, by increasing or decreasing a current that is supplied to a given circuit (a circuit such as an error amplifier whose response speed depends on the consumption current) in synchronism with a switching frequency.

The present invention has been made in order to achieve the above object, and a switching power supply device according to the present invention relates to a switching power supply device, which has means for controlling an on/off operation of a switching element that is connected to a DC power supply to output a DC voltage of a given voltage value, and randomly changing a frequency of a switching signal that allows the switching element to turn on/off, the switching power supply device including: a pseudo-random number generator circuit for generating random number data for randomly determining the frequency of the switching signal that allows the switching element to turn on/off; and a current control circuit for controlling a magnitude of a supply current to a given circuit section whose response speed depends on a consumption current according to the random number data that is generated by the pseudo-random number generator circuit.

In the above configuration, in the switching power supply device, the frequency of the switching signal of the switching element is changed at random on the basis of the random number data that has been generated by the pseudo-random number generator circuit. Also, the consumption current of the given circuit section (for example, a circuit such as an error amplifier whose response speed depends on the consumption current) is controlled in response to a change in the frequency of the switching element. In this situation, the consumption current is controlled so that the response speeds of the given control circuit becomes a response speed necessary and sufficient for the frequency of the switching signal.

Accordingly, the consumption current of the control circuit can be reduced together with a reduction in an effect of the noises in the switching power supply device in the switching power supply device.

Further, in the switching power supply device according to the present invention, in a case where the frequency of the switching signal changes at random, the current control circuit controls a magnitude of the consumption current so that the response speed of the given circuit section becomes a response speed necessary and sufficient to accept the frequency of the switching signal.

In the above configuration, the current control circuit controls the consumption current of the given circuit section so that the response speed of the given circuit section (such as an error amplifier) becomes a response speed necessary and sufficient to accept the frequency of the switching signal.

In this situation, the consumption current of the control circuit can be reduced together with a reduction in an effect of the noises in the switching power supply device.

Further, in the switching power supply device according to the present invention, the pseudo-random number generator circuit includes n-stage feedback shift registers for generating the random number data.

In the above configuration, the pseudo-random number generator circuit is configured by using a feedback shift register. As a result, the consumption current of the control circuit can be reduced together with a reduction in an effect of the noises without using specific hardware for generating the random number data.

Further, the switching power supply device according to the present invention further includes: a chopping wave oscillator having an oscillation frequency controlled according to the random number data which is generated by the pseudo-random number generator circuit; an error amplifier for comparing a feedback voltage of the output DC voltage with a given reference voltage; a PWM comparator for comparing a chopping wave signal that is output from the chopping wave oscillator with an output signal of the error amplifier to generate a PWM pulse signal for controlling the on/off operation of the switching element; a first current control circuit for determining a supply current to the PWM comparator in correspondence with the random number data that is generated by the pseudo-random number generator circuit; and a second current control circuit for determining a supply current to the error amplifier in correspondence with the random number data that is generated by the pseudo-random number generator circuit.

In the above configuration, in the switching power supply device, the frequency (frequency of the switching signal) of the chopping wave that is generated from the chopping wave oscillator is changed at random on the basis of the random number data that has been generated by the pseudo-random number generator circuit. Also, the consumption current is controlled so that the response speeds of the error amplifier and the PWM comparator become a response speed necessary and sufficient to accept the oscillation frequency of the chopping wave oscillator.

In this situation, the consumption current of the control circuit can be reduced together with a reduction in an effect of the noises in the switching power supply device.

In the switching power supply circuit according to the present invention, it is possible to reduce the consumption current of the given circuit (for example, the error amplifier or the PWM comparator) together with a reduction in the effect of the switching noises.

### BRIEF DESCRIPTION OF THE DRAWINGS

FIG. 1 is a diagram showing a structural example of a switching power supply device according to the present invention.

FIG. 2 is a diagram showing a structural example of an error amplifier.

FIG. 3 is a specific structural example showing a pseudo-random number generator circuit.

FIG. 4 is a diagram showing a specific structural example of a current control circuit.

FIG. 5 is a diagram showing an example of weighing a chopping wave oscillation frequency and a current control circuit.

FIG. 6 is a diagram showing a structural example of a conventional switching power supply device.

### DETAILED EXPLANATION OF PREFERRED EMBODIMENTS

Subsequently, a description will be given of the best mode for carrying out the present invention with reference to the drawings.

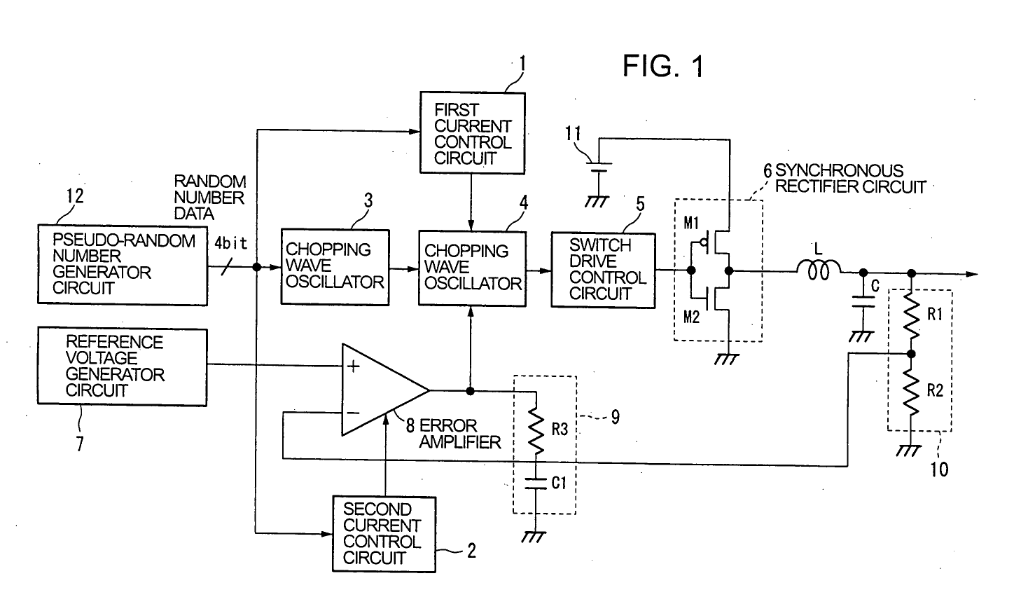

FIG. 1 is a diagram showing the structural example of a switching power supply device (DC/DC converter) according to the present invention.

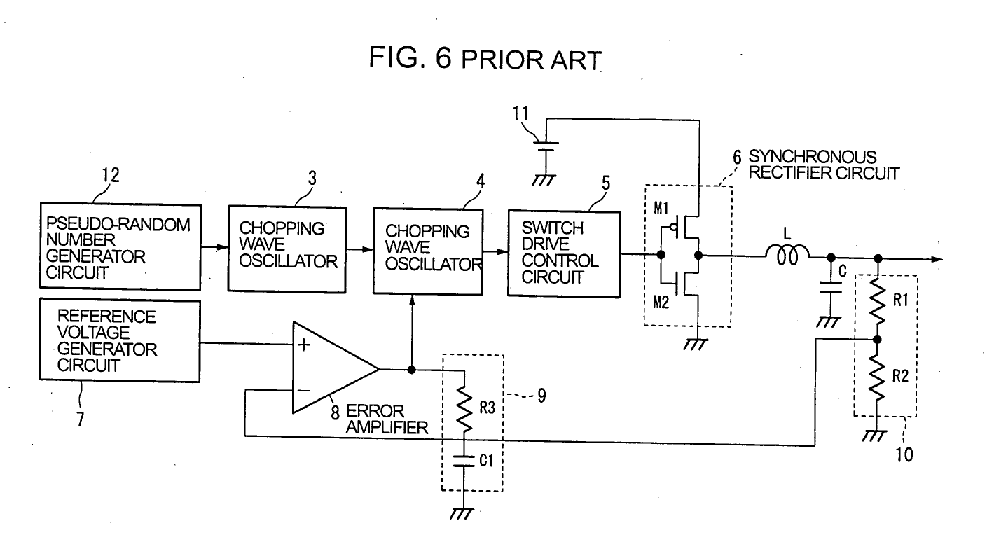

The switching power supply device shown in FIG. 1 includes, as in the conventional switching power supply device shown in FIG. 6, a pseudo-random number generator circuit 12, a chopping wave oscillator 3, a PWM comparator 4, a switch drive control circuit 5, a synchronous rectifier circuit 6 that is made up of a PMOS transistor M1 and an NMOS transistor M2 which are switching elements, an external inductor L, an external capacitor C, a reference voltage generator circuit 7, an error amplifier 8, a stabilizer circuit 9 that is made up of a resistor R3 and a capacitor C1, and an output voltage detector circuit 10 that is made up of resistors R1 and R2. The circuit elements added in this circuit are a first current control circuit 1 and a second current control circuit 2.

In the switching power supply device shown in FIG. 1, random number data of four bits is generated by the pseudo-random number generator circuit 12, the oscillation frequency is determined according to the random number data, and a chopping wave having a constant amplitude is output from the chopping wave oscillator 3. A D/A converter that outputs a current responsive to, for example, the random number data of four bits is built in the chopping wave oscillator 3, and the chopping wave of a constant amplitude is generated by integrating the output current of the D/A converter. For that reason, the frequency (period) of the chopping wave which is generated by the chopping wave oscillator 3 is changed at random according to the random number data of four bits. The random number data is not limited to four bits but can be of any bits.

The chopping wave that is generated by the chopping wave oscillator 3 is an input signal of the PWM comparator 4. The signal of the chopping wave and an error signal from the error amplifier 8 are compared with each other by the PWM comparator 4. In this example, the error signal of the error amplifier 8 is a signal that is output through the stabilizing circuit 9.

In the PWM comparator 4, the chopping wave is sliced according to the output level of the error signal, and converted into a PWM pulse signal. The PWM pulse signal is input to the switch drive control circuit 5 to conduct the switching control of the synchronous rectifier circuit 6 that is made up of a switching PMOS transistor Ml and a switching NMOS transistor M2.

In the synchronous rectifier circuit 6, the switching PMOS transistor M1 is turned on at a timing synchronous with the PWM pulse signal, and a current flows in the external inductor L from the input power supply 11. Also, when the switching PMOS transistor M1 turns off, the switching NMOS transistor M2 turns on after a given delay time, and a current flows into the external inductor L from the ground.

As described above, the voltage value of the input power supply 11 is smoothed by the external inductor L and the external capacitor C by the aid of the synchronous rectifier circuit 6 that is subjected to switching control, converted into a given voltage value, and outputted. The output voltage in this situation is divided by the output voltage detection resistors R1 and R2, and input to the error amplifier 8 as a feedback signal. The error amplifier 8 compares the voltages from the output voltage detection resistors R1 and R2 which are in proportion to the output voltage with a reference voltage that is generated by the reference voltage generator circuit 7 to output the error signal. The error signal is input to the PWM comparator 4 through the stabilizer circuit 9 as described above.

In this example, the first current control circuit 1 for the PWM comparator 4 and the second current control circuit 2 for the error amplifier 8 are circuit sections that are added to the conventional switching power supply device shown in FIG. 6.

In this example, when the first current control circuit 1 functions such that the supply current (consumption current) to the PWM comparator 4 becomes large when the oscillation frequency (oscillation frequency that is determined according to the random number data of four bits from the pseudo-random number generator circuit 12) of the chopping wave oscillator 3 is high. Likewise, when the second current control circuit 2 functions such that the supply current (consumption current) to the error amplifier 8 becomes large when the oscillation frequency of the chopping wave oscillator 3 which is determined according to the pseudo-random number generator circuit 12 is high. The oscillation frequency of the chopping wave due to the chopping wave oscillator 3 is changed, for example, in a range of from 0.5 MHz to 2 MHz in a unit of 0.5 MHz with a fundamental oscillation frequency of 1 MHz.

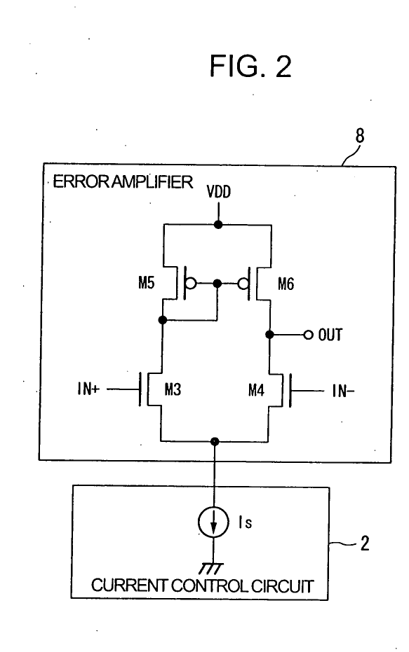

FIG. 2 is a diagram showing the structural example of the error amplifier 8, which is an example of a differential amplifier circuit that is made up of PMOSs (M5, M6) and NMOSs (M3, M4) and is a well-known structure. A constant current is supplied to the error amplifier 8 by the aid of the current control circuit 2. The response speed (the response speed of an output OUT to an input IN) of the error amplifier 8 depends on the magnitude of a constant current Is that flows by the aid of the current control circuit 2, and the response speed of the error amplifier 8 increases more as the constant current Is is larger. The PWM comparator 4 is made up of the same differential amplifier circuit and current control circuit.

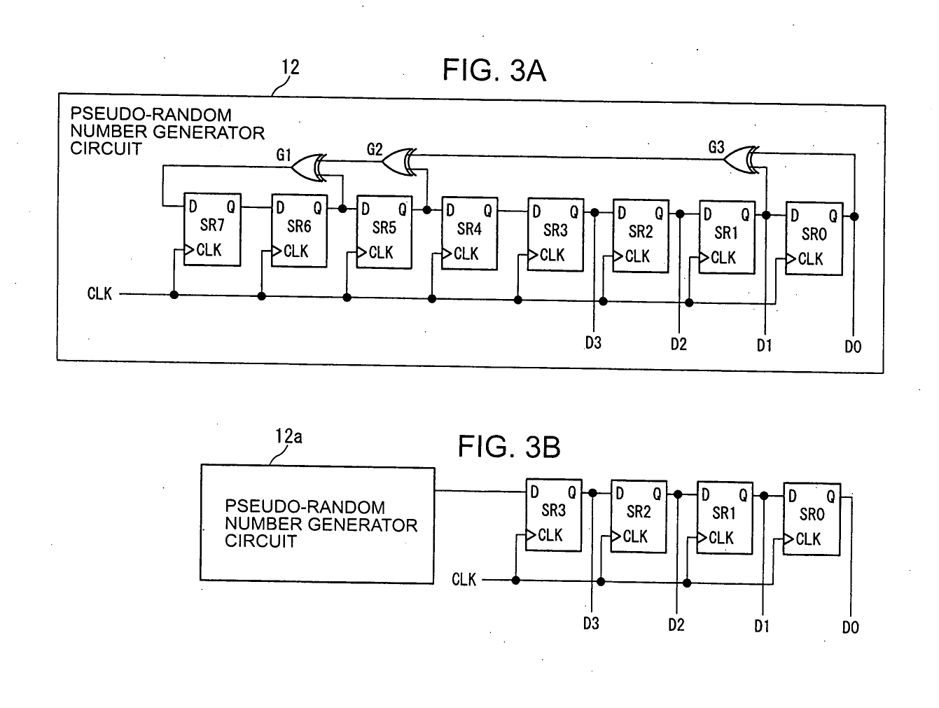

FIG. 3 is a diagram showing a specific structural example of the pseudo-random number generator circuit 12. In the pseudo-random number generator circuit 12 shown in FIG. 3(A), eight-stage feedback shift registers (hereinafter referred to simply as “shift registers”) SR0 to SR7 constitute a generator circuit of a pseudo-random series having a length of 255 bits.

The Q output of the shift register SR6 is input to one input terminal of an exclusive OR element G1, and the Q terminal of the shift register SR5 is input to one input terminal of an exclusive OR element G2. Also, the Q output of the shift register SR1 is input to one input terminal of an exclusive OR element G3. In addition, the Q output of the final-stage shift register SR0 is fed back to an input terminal D of the initial-stage shift register SR7 through the exclusive OR elements G3, G2, and G1.

Random digital values D0 to D3 of those eight-stage feedback shift registers SR7 to SR0 are output to the chopping wave oscillator 3, the first current control circuit 1, and the second current control circuit 2 as the random number data (D0 to D3) of four bits. The random number data (D0 to D3) of four bits change over the frequency set value of the chopping wave in a random period, and determines the magnitude of the control current in each of the current control circuits 1 and 2.

FIG. 3(B) is a diagram showing another example of generating random number data (D0 to D3) of four bits. In the example shown in FIG. 3(B), the random number data of one bit which is output from the pseudo-random number generator circuit 12a is sequentially taken in by the shift register of four bits to output the random number data (D0 to D3) of four bits.

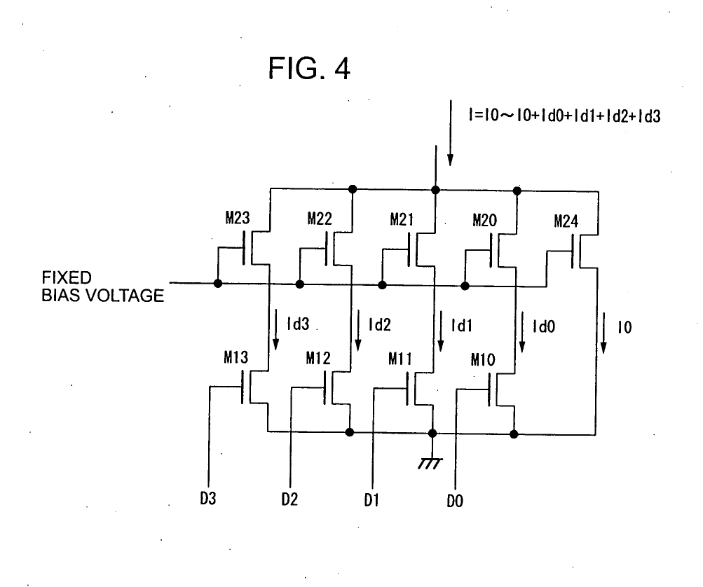

FIG. 4 is a circuit diagram showing a specific structural example of the first current control circuit 1 and the second current control circuit 2. The current control circuit shown in FIG. 4 is an example in which the current control circuit is constituted by nine NMOSs.

A fixed bias voltage is applied to the gates of upper-stage five NMOSs (M24, M20, M21, M22, M23), and each of the upper-stage NMOSs (M24, M20, M21, M22, M23) constitutes a constant current source. A constant current I0 flows in the NMOS (M24), a constant current Id0 flows in the NMOS (M20), a constant current Id1 flows in the NMOS (M21), a constant current Id2 flows in the NMOS (M22), and a constant current Id3 flows in the NMOS (M23).

Four lower-stage NMOSs (M10, M11, M12, M13) correspond to the respective upper-stage NMOSs (M20, M21, M22, M23) so as to control the on/off operation of the constant currents (Id0, Id1, Id2, Id3) that flow from the upper-stage NMOSs (M20, M21, M22, M23), respectively.

The random number data D0 is applied to the gate of the NMOS (M10), the random number data D1 is applied to the gate of the NMOS (M11), the random number data D2 is applied to the gate of the NMOS (M12), and the random number data D3 is applied to the gate of the NMOS (M13). As a result, in the lower-stage NMOSs, only the NMOS having a gate to which a signal of logical “1” is supplied among the random number data (D0, D1, D2, D3) of four bits turns on, thereby enabling the current to flow in the upper-stage NMOSs.

For example, in the case where the random number data (D0, D1, D2, D3) of four bits is (0,0,0,0), all of the lower-stage NMOSs turn off, and only the current I0 of a PMOS (M24) flows in the current control circuit.

Also, in the case where the random number data (D0, D1, D2, D3) of four bits is (1, 1, 1, 1), all of the lower-stage NMOSs turn on, and a current Id0 of a PMOS (M20), a current Id1 of a PMOS (M21), a current Id2 of a PMOS (M22), and a current Id3 of a PMOS (M23) flow in the current control circuit. A current of I=I0+Id0+Id1+Id2+Id3 flows in the current control circuit.

As described above, it is possible to control a current value that flows in the current control circuit according to the data value of the random number data (D0, D1, D2, D4) of four bits. As a result, it is possible to control the oscillation frequency of the chopping wave oscillator 3 according to the random number data (D0, D1, D2, D3) of four bits, and also to control the current value of the current control circuit in response to the oscillation frequency of the chopping wave oscillator 3.

That is, when the frequency of the chopping wave oscillator 3 increases, the consumption currents in the PWM comparator 4 and the error amplifier 8 are increased, to thereby accept the high frequency. When the frequency decreases, the consumption currents in the PWM comparator 4 and the error amplifier 8 are decreased, to thereby reduce the consumption currents in the circuit sections of the switching power supply device.

Also, it is possible to weigh the random number data (D0, D1, D2, D3) of four bits.

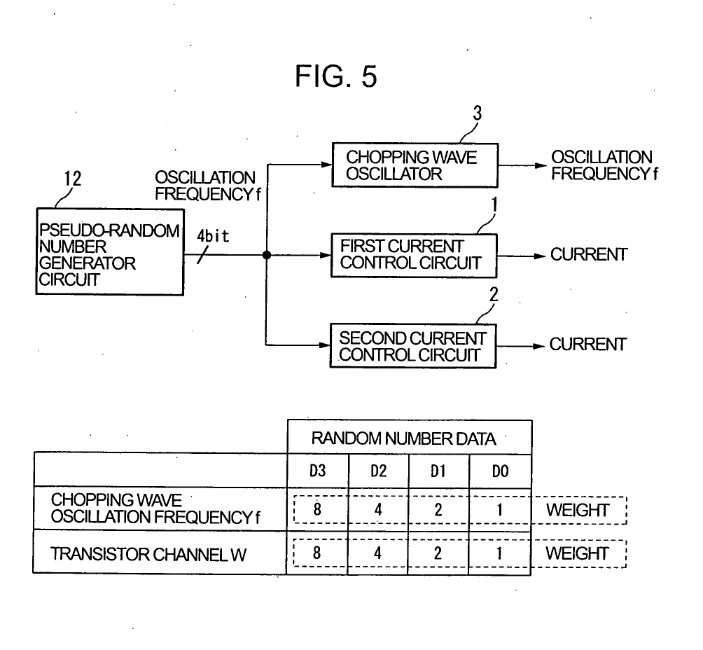

For example, as shown in FIG. 5, it is possible to give the same weight to both of an oscillation frequency f of the chopping wave oscillator 3 and a transistor channel width by the aid of the random number data (D0, D1, D2, D3). In an example shown in FIG. 5, weights n of (1, 2, 4, 8) are associated with the random number data (D0, D1, D2, D3).

As described above, when the weights n are selected according to the random number data of four bits, the oscillation frequency f of the chopping wave oscillator 3 can be set to satisfy the following expression when it is assumed that f0 is the reference frequency (lowest oscillation frequency), and fs is a fixed increment frequency:

f=f0 (reference frequency) +Σn×fs (frequency of increment) where n is any one of 1, 2, 4, and 8.

In this case, the same weight n is associated with the transistor channel widths (the magnitude of the constant current) of the upper-stage NMOSs (M20, M21, M22, M23) that constitute the constant current circuit. Therefore, it is possible to change the consumption current of the error amplifier 8 and the PWM comparator 4 according to a change in the oscillation frequency of the chopping wave oscillator 3.

As was described above, in the switching power supply device according to the present invention, when the oscillation frequency of the chopping oscillator 3 which is determined according to the random number data from the pseudo-random number generator circuit 12 is high, the first current control circuit 1 and the second current control circuit 2 supply the sufficient consumption current to the PWM comparator 4 and the error amplifier 8. When the oscillation frequency of the chopping oscillator 3 is low, the first current control circuit 1 and the second current control circuit 2 supply the necessary and sufficient consumption current to the PWM comparator 4 and the error amplifier 8. As a result, it is possible to reduce the consumption current of the switching power supply.

The embodiment of the present invention has been described above. It is needless to say that the switching power supply device according to the present invention is not limited to only the examples described with reference to the drawings but can be diversely modified within a scope that does not deviate from the gist of the present invention.

1. A switching power supply device, which has means for controlling an on/off operation of a switching element that is connected to a DC power supply to output a DC voltage of a given voltage value, and randomly changing a frequency of a switching signal that allows the switching element to turn on/off, the switching power supply device comprising:
a pseudo-random number generator circuit for generating random number data for randomly determining the frequency of the switching signal that allows the switching element to turn on/off; and
a current control circuit for controlling a magnitude of a supply current to a given circuit section whose response speed depends on a consumption current according to the random number data that is generated by the pseudo-random number generator circuit.

2. A switching power supply device according to claim 1, wherein in a case where the frequency of the switching signal changes at random, the current control circuit controls a magnitude of the consumption current so that the response speed of the given circuit section becomes a response speed necessary and sufficient to accept the frequency of the switching signal.

3. A switching power supply device according to claim 1, wherein the pseudo-random number generator circuit includes n-stage feedback shift registers for generating the random number data.

4. A switching power supply device according to claim 1, further comprising:
a chopping wave oscillator having an oscillation frequency controlled according to the random number data which is generated by the pseudo-random number generator circuit;
an error amplifier for comparing a feedback voltage of the output DC voltage with a given reference voltage;
a PWM comparator for comparing a chopping wave signal that is output from the chopping wave oscillator with an output signal of the error amplifier to generate a PWM pulse signal for controlling the on/off operation of the switching element;
a first current control circuit for determining a supply current to the PWM comparator in correspondence with the random number data that is generated by the pseudo-random number generator circuit; and
a second current control circuit for determining a supply current to the error amplifier in correspondence with the random number data that is generated by the pseudo-random number generator circuit.
